(19) United States
(12) Patent Application Publication
(10) Pub. No.: US 2004/0123262 A1
(43) Pub. Date: Jun. 24, 2004

(54) Automatic placement and routing system

(75) Inventors: Mitsutoshi Shirota, Tokyo (JP); Kazuhiro Takahashi, Tokyo (JP)

Correspondence Address: BURN, DOANE, SWECKER & MATHIS, L.L.P., P.O. Box 1404, Alexandria, VA, 22313-1404, US

(73) Assignee: Renesas Technology Corporation

(21) Appl. No.: 10/457,546

(22) Filed: Jun. 10, 2003

(30) Foreign Application Priority Data
Dec. 20, 2002 (JP) 2002-370738

(51) Int. Cl. G06F 17/50

(52) U.S. Cl. 716/14

(57) ABSTRACT

An automatic placement and routing system includes a general routing unit for deciding general routing of connections according to a netlist; a calculation unit for calculating a sum total of distances of the connections along the general routing; a revision unit for revising the general routing of a specified connection, when the sum total of the distances is greater than a reference value; and a detailed routing unit for deciding, when the sum total of the distances is less than the reference value, the detailed routing of the individual connections according to the general routing the general routing unit decides, and for deciding, when the sum total is greater than the reference value, the detailed routing of the individual connections according to the revised general routing the revision unit produces. It can reduce wiring congestion and a layout size.

### BACKGROUND OF THE INVENTION

1. Field of the Invention

The present invention relates to an automatic placement and routing system used for designing semiconductor circuits.

2. Description of Related Art

Generally, redundant memory cells are prepared in addition to regular memory cells to repair defects of a semiconductor memory. If defective memory cells are found in a wafer test, they are replaced by the redundant memory cells. The replacement by the redundant memory cells is carried out by cutting fuses on the top layer of a semiconductor chip by a laser trimmer apparatus.

Conventionally, a fuse circuit including a lot of fuses is placed in the same region as the memory circuit including the memory cells and their peripheral circuit. Recently, to improve the design efficiency of a semiconductor memory and the scale of integration of a semiconductor chip, a fuse circuit is sometimes placed in a different region from that of the memory circuit (see, Relevant Reference 1, for example).

Relevant Reference 1: Japanese patent application laid-open No. 2000-114384, pp. 4-5 and FIG. 1.

Generally, connections between the memory circuit and fuse circuit are specified in advance. Accordingly, placing the fuse circuit in a region different from the memory circuit sometimes causes considerable wiring congestion between the memory circuit and fuse circuit, thereby increasing the layout size.

### SUMMARY OF THE INVENTION

The present invention is implemented to solve the foregoing problem. It is therefore an object of the present invention to provide an automatic placement and routing system capable of reducing the wiring congestion between the memory circuit and fuse circuit as well as the layout size, when the fuse circuit is placed in a region different from the memory circuit.

According to a first aspect of the present invention, there is provided an automatic placement and routing system including a calculation unit for calculating a predetermined information value about a net; and a revision unit for revising general routing of at least one of connections when the predetermined information value about the net is greater than a reference value.

Here, the predetermined information value about the net may be a sum total of distances of the individual connections along the general routing, a sum total of distances of the individual connections between the terminals of the memory cells and the terminals of the fuse cells, or a density of wiring components parallel to opposing sides of the memory cells and the fuse cells.

According to a second aspect of the present invention, there is provided an automatic placement and routing system including a calculation unit for calculating, every time a detailed routing unit decides the detailed routing of a connection, a wiring congestion between memory cells and fuse cells from the detailed routing of the connections whose detailed routing has already been decided; and a revision unit for revising, when the wiring congestion is greater than a reference value, the general routing of at least one of the connections whose general routing has already been decided, and for revising the detailed routing of the at least one of the connections in accordance with the revision of the general routing.

According to a third aspect of the present invention, there is provided an automatic placement and routing system including a calculation unit for calculating, every time a general routing unit decides the general routing of a connection, a wiring congestion between memory cells and fuse cells from the general routing of the connections whose general routing has already been decided; and a revision unit for revising, when the wiring congestion is greater than a reference value, the general routing of at least one of the connections whose general routing has already been decided.

The foregoing configurations enables the design of a semiconductor circuit that can reduce the wiring congestion between the memory macro cells and fuse macro cell, and the layout size.

### BRIEF DESCRIPTION OF THE DRAWINGS

FIG. 1 is a block diagram showing a configuration of a semiconductor circuit design system to which embodiments of an automatic placement and routing system are applied;

FIG. 2 is a block diagram showing a configuration of an embodiment 1 of the automatic placement and routing system in accordance with the present invention;

FIG. 3 is a flowchart illustrating the operation of the embodiment 1 of the automatic placement and routing system;

FIG. 4 is a layout diagram of a semiconductor circuit designed using the embodiment 1 of the automatic placement and routing system;

FIG. 5 is a block diagram showing a configuration of an embodiment 2 of the automatic placement and routing system in accordance with the present invention;

FIG. 6 is a flowchart illustrating the operation of the embodiment 2 of the automatic placement and routing system;

FIG. 7 is a layout diagram of a semiconductor circuit designed using the embodiment 2 of the automatic placement and routing system;

FIG. 8 is a block diagram showing a configuration of an embodiment 3 of the automatic placement and routing system in accordance with the present invention;

FIG. 9 is a diagram illustrating a state in which terminals of memory macro cells are assumed to be located at the center of memory macro cells;

FIG. 10 is a flowchart illustrating the operation of the embodiment 3 of the automatic placement and routing system;

FIG. 11 is a block diagram showing a configuration of an embodiment 4 of the automatic placement and routing system in accordance with the present invention;

FIG. 12 is a flowchart illustrating the operation of the embodiment 4 of the automatic placement and routing system;

FIG. 13 is a layout diagram of a semiconductor circuit designed using the embodiment 4 of the automatic placement and routing system;

FIG. 14 is a block diagram showing a configuration of an embodiment 5 of the automatic placement and routing system in accordance with the present invention;

FIG. 15 is a flowchart illustrating the operation of the embodiment 5 of the automatic placement and routing system;

FIG. 16 is a diagram sequentially illustrating layouts of a semiconductor circuit designed using the embodiment 5 of the automatic placement and routing system;

FIG. 17 is a block diagram showing a configuration of an embodiment 6 of the automatic placement and routing system in accordance with the present invention;

FIG. 18 is a flowchart illustrating the operation of the embodiment 6 of the automatic placement and routing system; and

FIG. 19 is a diagram sequentially illustrating layouts of a semiconductor circuit designed using the embodiment 6 of the automatic placement and routing system.

### DETAILED DESCRIPTION OF THE PREFERRED EMBODIMENTS

The invention will now be described with reference to the accompanying drawings.

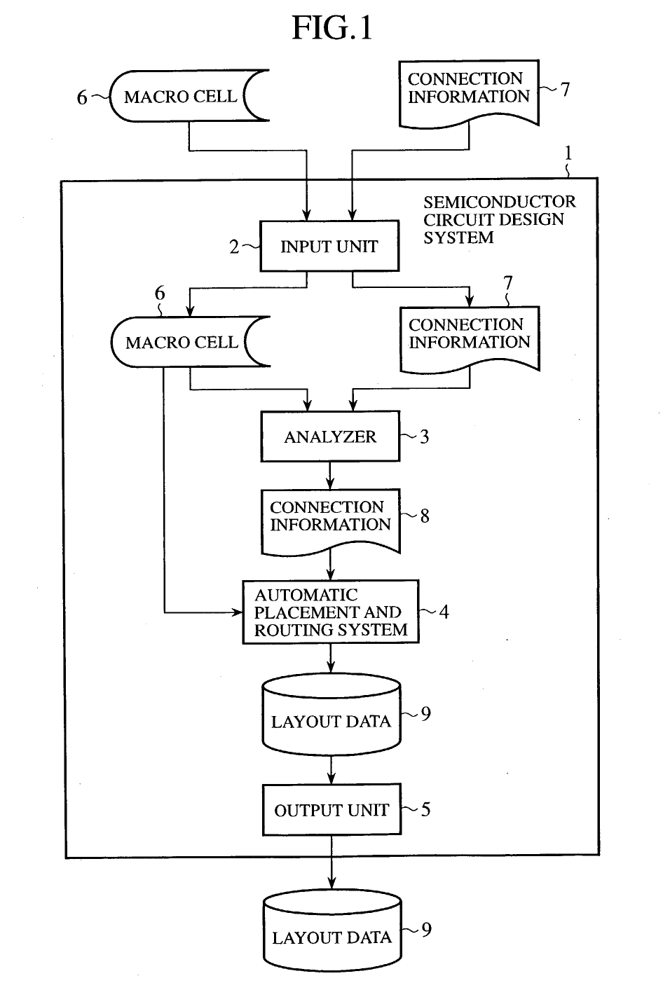

FIG. 1 is a block diagram showing a configuration of a semiconductor circuit design system to which embodiments of the automatic placement and routing system in accordance with the present invention are applied.

The semiconductor integrated circuit design system 1 includes an input unit 2, an analyzer 3, an automatic placement and routing system 4 and an output unit 5.

The input unit 2 reads macro cells 6 of a memory circuit and fuse circuit, which are registered in a cell library (not shown), and connection information 7 output from a logic design system (not shown). The connection information 7 describes a (net) list indicating which terminals of which macro cells are to be connected to which terminals of which macro cells. It is assumed here that although the memory circuit includes the memory cells and their peripheral circuits, it does not include the fuse circuit. In addition, the fuse circuit includes a lot of fuses that are broken by a laser trimmer when defective memory cells are replaced by redundant memory cells.

The analyzer 3 receives the macro cells 6 and connection information 7 the input unit 2 reads. Then, it analyzes in accordance with the connection information 7 which terminals of which macro cells 6 the input unit 2 reads are to be connected to which terminals of which macro cells 6 by individual connections. The analyzer 3 outputs connection information 8 describing the connections thus obtained.

The automatic placement and routing system 4 receives the connection information 8 the analyzer 3 outputs and the macro cells 6 the input unit 2 reads. Then, in accordance with the connection information 8, it carries out the placement of the macro cells 6 and the routing between the macro cells 6 placed, and outputs layout data 9 after the placement and routing.

The output unit 5 outputs the layout data 9 after the placement and routing supplied from the automatic placement and routing system 4 to the outside of the semiconductor integrated circuit design system 1.

Next, the embodiments of the automatic placement and routing system in accordance with the present invention will be described. The embodiments of the automatic placement and routing system carry out the placement of the macro cells of a memory circuit (called “memory macro cells” from now on) and the macro cells of a fuse circuit (called “fuse macro cells” from now on), and the routing between the memory macro cells and fuse macro cells that are placed.

### Embodiment 1

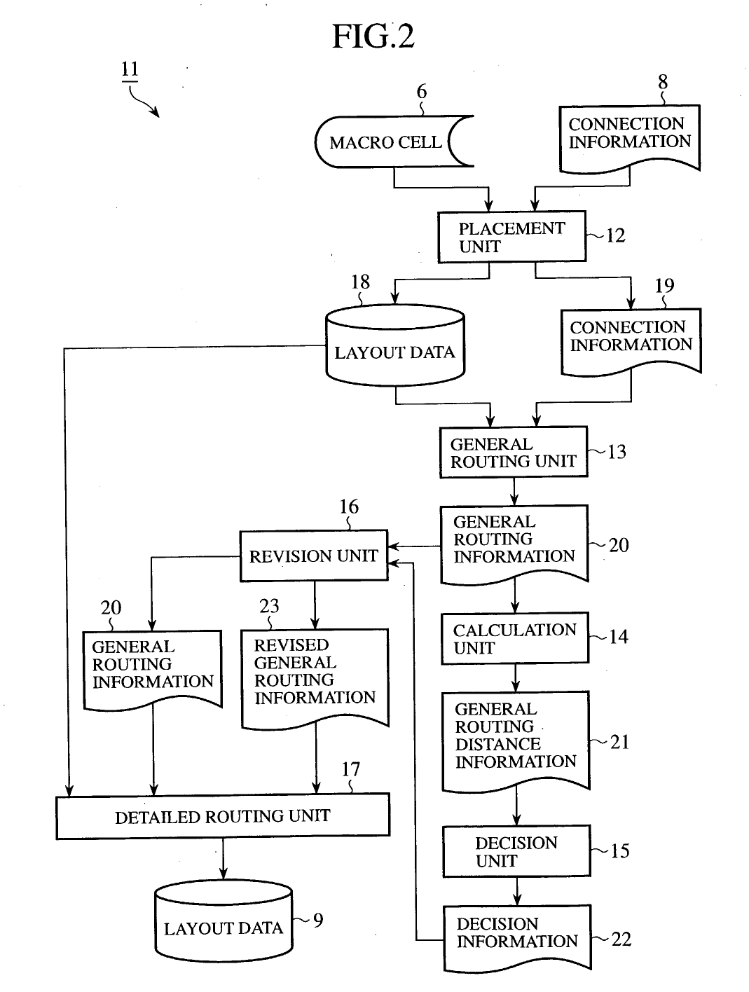

FIG. 2 is a block diagram showing a configuration of an embodiment 1 of the automatic placement and routing system in accordance with the present invention.

The embodiment 1 of the automatic placement and routing system 11 includes a placement unit 12, a general routing unit 13, a calculation unit 14, a decision unit 15, a revision unit 16 and a detailed routing unit 17.

The placement unit 12 receives the connection information 8 the analyzer 3 outputs and the macro cells 6 the input unit 2 reads. The connection information 8 describes which terminals of the memory macro cell the input unit 2 reads are to be connected to which terminals of the fuse cell by the individual connections. Then, the placement unit 12 places the memory macro cells and fuse macro cell in accordance with the connection information 8. The placement unit 12 outputs layout data 18 after the macro cell placement, and connection information 19 describing which terminals of the memory macro cells after the placement are to be connected to which terminals of the fuse macro cell by the individual connections.

The general routing unit 13 receives the layout data 18 and connection information 19 after the macro cell placement the placement unit 12 outputs. Then, it decides general routing of the individual connections in accordance with the connection information 19. The general routing unit 13 outputs resultant information about the general routing (called “general routing information” from now on) 20.

The calculation unit 14 receives the general routing information 20 the general routing unit 13 outputs. Then, it calculates the sum total of the distances of the individual connections along the general routing from the general routing information 20. The calculation unit 14 outputs information about the sum total of the distances of the individual connections along the general routing (called “general routing distance information” from now on) 21.

The decision unit 15 receives the general routing distance information 21 the calculation unit 14 outputs. Then, it makes a decision as to whether the sum total of the distances of the individual connections along the general routing is less than a reference value the decision unit 15 holds. By setting the reference value at an appropriate value, the decision unit 15 can make a decision as to whether the sum total of the distances of the individual connections along the general routing is minimum. The decision is made by comparing the general routing distance information 21 with the reference value. The decision unit 15 outputs information about the decision result (called “decision information” from now on) 22.

The revision unit 16 receives the decision information 22 the decision unit 15 outputs and the general routing information 20 the general routing unit 13 outputs. Then, when the sum total of the distances of the individual connections along the general routing is less than the reference value, it outputs the general routing information 20 fed from the general routing unit 13 without revising the general routing of the individual connections. In contrast, when the sum total is greater than the reference value, it revises the general routing of a specified connection, and outputs information about the general routing after the revision (called “revised general routing information”) 23. The revision of the general routing is carried out by exchanging the terminals of the fuse macro cell to which the terminals of the memory macro cells are connected. The exchange of the terminals of the fuse macro cell is carried out on a memory macro cell by memory macro cell basis. The exchange of the terminals of the fuse macro cell is carried out in such a manner that the sum total of the distances of the individual connections along the general routing becomes less than the reference value as a result of the exchange of the terminals of the fuse macro cell.

The detailed routing unit 17 receives the general routing information 20 or revised general routing information 23 the revision unit 16 outputs and the layout data 18 after the macro cell placement the placement unit 12 outputs. Then, it decides the final routing (detailed routing) of the individual connections in accordance with the general routing information 20 or revised general routing information 23. The detailed routing unit 17 outputs the layout data 9 after the placement and routing.

Next, the operation of the present embodiment 1 will be described.

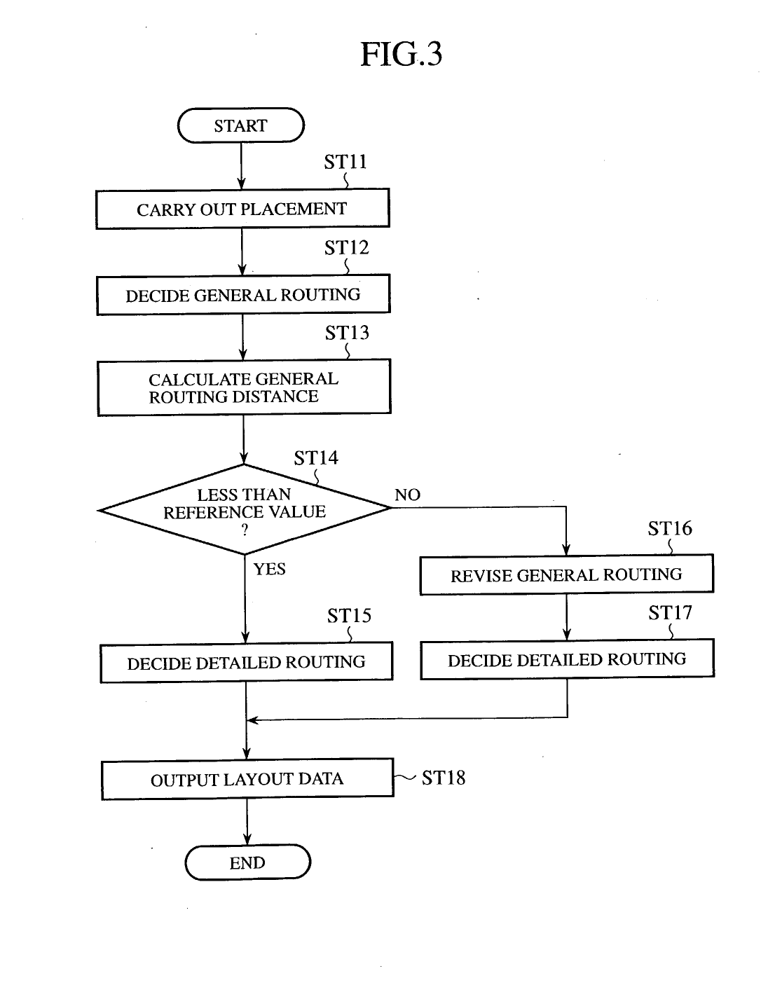

FIG. 3 is a flowchart illustrating the operation of the embodiment 1 of the automatic placement and routing system.

First, the placement unit 12 receives the connection information 8 the analyzer 3 outputs and the macro cells 6 the input unit 2 reads, and carries out placement of the memory macro cells and fuse macro cells in accordance with the connection information 8 (step ST11).

Subsequently, the general routing unit 13 receives the layout data 18 and connection information 19 after the macro cell placement the placement unit 12 outputs, and decides the general routing of the individual connections in accordance with the connection information 19 (step ST12).

Subsequently, the calculation unit 14 receives the general routing information 20 the general routing unit 13 outputs, and calculates the sum total of the distances of the individual connections along the general routing from the general routing information 20 (step ST13).

Subsequently, the decision unit 15 receives the general routing distance information 21 the calculation unit 14 outputs, and makes a decision as to whether the sum total of the distances of the individual connections along the general routing is less than the reference value (step ST14). The decision is made by comparing the general routing distance information 21 with the reference value.

Subsequently, the revision unit 16 receives the decision information 22 the decision unit 15 outputs and the general routing information 20 the general routing unit 13 outputs.

When the sum total of the distances of the individual connections along the general routing is less than the reference value, the revision unit 16 does not revise the general routing of the individual connections. Subsequently, the detailed routing unit 17 receives the general routing information 20 the revision unit 16 outputs and the layout data 18 after the macro cell placement the placement unit 12 outputs, and decides the final routing (detailed routing) of the individual connections in accordance with the general routing information 20 (step ST15).

In contrast, when the sum total of the distances of the individual connections along the general routing is greater than the reference value, the revision unit 16 revises the general routing of a specified connection (step ST16). The revision of the general routing is carried out by exchanging the terminals of the fuse macro cell to which the terminals of the memory macro cells are connected. The exchange of the terminals of the fuse macro cell is made on a memory macro cell by memory macro cell basis. The exchange of the terminals of the fuse macro cell is carried out in such a manner that the sum total of the distances of the individual connections along the general routing becomes less than the reference value. Subsequently, the detailed routing unit 17 receives the revised general routing information 23 the revision unit 16 outputs and the layout data 18 after the macro cell placement the placement unit 12 outputs, and decides the complete routing (detailed routing) of the individual connections in accordance with the revised general routing information 23 (step ST17).

Subsequently, the detailed routing unit 17 outputs the layout data 9 after the placement and routing (step ST18).

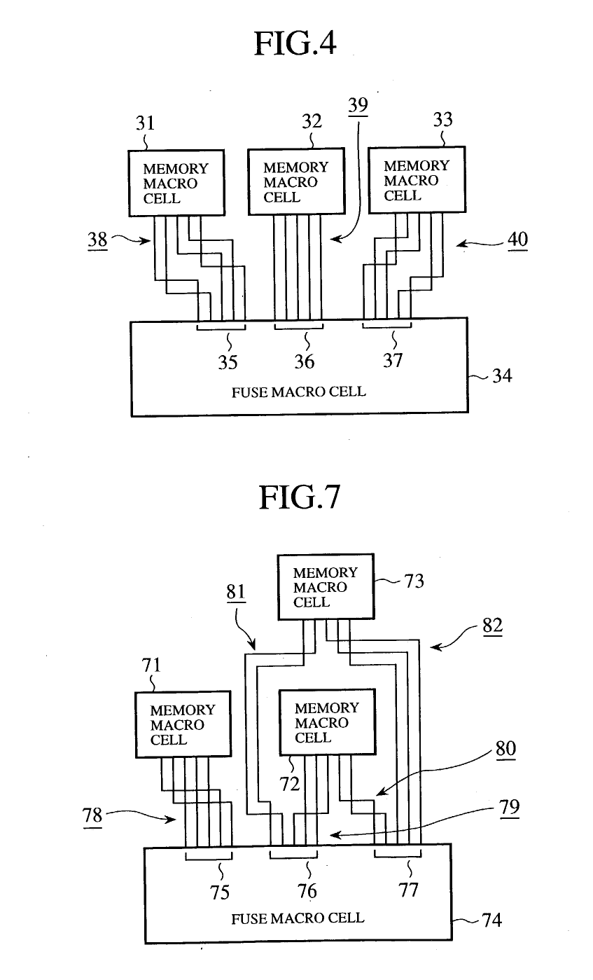

FIG. 4 is a layout diagram illustrating a semiconductor circuit designed using the embodiment 1 of the automatic placement and routing system.

In the layout diagram as shown in FIG. 4, first to third memory macro cells 31-33 are placed oppositely to a fuse macro cell 34.

On the sides of the first to third memory macro cells 31-33 closest to the fuse macro cell 34, there are provided terminals for connecting them to the terminals of the fuse macro cell 34. On the other hand, on the side of fuse macro cell 34 closest to the first to third memory macro cells 31-33, there are provided terminals for connecting it to the terminals of the first to third memory macro cells 31-33. The terminals of the fuse macro cell 34 are shown as first to third terminal sets 35-37 that are separated apart on a memory macro cell by memory macro cell basis from the left-hand side. The terminals of the first to third memory macro cells 31-33 are connected to the terminals of the fuse macro cell 34 on a memory macro cell by memory macro cell basis.

The terminals of the first memory macro cell 31 are connected to the terminals of the first terminal set 35 of the fuse macro cell 34 via a first wiring bundle 38 consisting of five wires. The terminals of the second memory macro cell 32 are connected to the terminals of the second terminal set 36 of the fuse macro cell 34 via a second wiring bundle 39 consisting of five wires. The terminals of the third memory macro cell 33 are connected to the terminals of the third terminal set 37 of the fuse macro cell 34 via a third wiring bundle 40 consisting of five wires.

In contrast, in a layout diagram (not shown) of a semiconductor circuit designed by a conventional automatic placement and routing system, for example, the terminals of the first memory macro cell 31 are connected to the terminals of the third terminal sets 37 of the fuse macro cell 34, the terminals of the second memory macro cell 32 are connected to the terminals of the second terminal sets 36 of the fuse macro cell 34, and the terminals of the third memory macro cell 33 are connected to the terminals of the first terminal sets 35 of the fuse macro cell 34.

In the present embodiment 1, the terminals of the fuse macro cell 34, to which the terminals of the first to third memory macro cells 31-33 are connected, are exchanged on a memory macro cell by memory macro cell basis so that the sum total of the distances of the individual connections along the general routing becomes less than the reference value. In the conventional case, however, the connections between the first to third memory macro cells 31-33 and the fuse macro cell 34 are determined in advance. Accordingly, the embodiment 1 is smaller than the conventional example in the wiring congestion between the first to third memory macro cells 31-33 and the fuse macro cell 34.

As described above, the present embodiment 1 calculates the sum total of the distances of the individual connections along the general routing, and revises the general routing in such a manner that the sum total becomes less than the reference value. Thus, it can reduce the wiring congestion between the memory macro cells and fuse macro cell by setting the reference value at an appropriate value. Consequently, it makes it possible to design a semiconductor circuit with a smaller layout size.

Although the present embodiment 1 handles the case where the revision of the general routing is carried out once to make the sum total of the distances of the individual connections along the general routing less than the reference value, this is not essential. For example, it can be configured such that the sum total of the distances of the individual connections along the general routing is made less than the reference value by carrying out the revision of the general routing a plurality of times.

### Embodiment 2

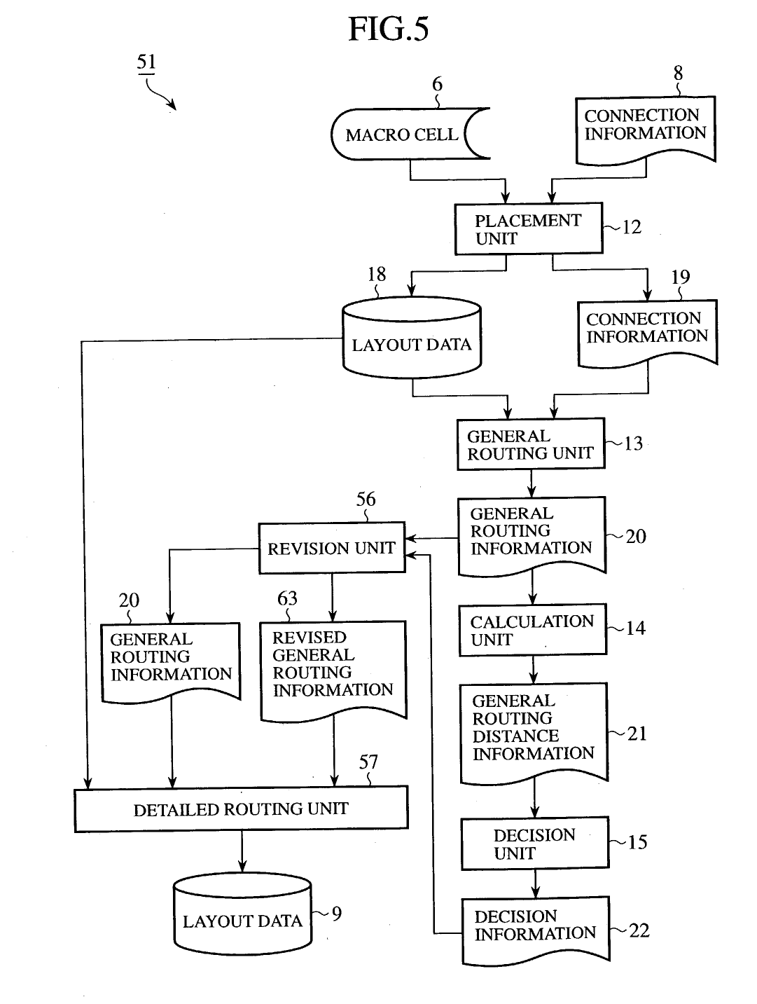

FIG. 5 is a block diagram showing a configuration of an embodiment 2 of the automatic placement and routing system in accordance with the present invention.

An automatic placement and routing system 51 of the embodiment 2 includes the placement unit 12, the general routing unit 13, the calculation unit 14, the decision unit 15, a revision unit 56, and a detailed routing unit 57.

The placement unit 12, general routing unit 13, calculation unit 14 and decision unit 15 are the same as those of the foregoing embodiment 1.

The revision unit 56 receives the decision information 22 the decision unit 15 outputs and the general routing information 20 the general routing unit 13 outputs. Then, when the sum total of the distances of the individual connections along the general routing is less than the reference value, it outputs the general routing information 20 fed from the general routing unit 13 without revising the general routing of the individual connections. In contrast, when the sum total is greater than the reference value, the revision unit 56 revises the general routing of a specified connection, and outputs information about the general routing after the revision (called “revised general routing information” from now on) 63. The revision of the general routing is made by exchanging the terminals of the fuse macro cell to which the terminals of the memory macro cells are connected. The exchange of the terminals of the fuse macro cell is carried out on a terminal by terminal basis. The exchange of the terminals of the fuse macro cell is carried out such that the sum total of the distances of the individual connections along the general routing becomes less than the reference value.

The detailed routing unit 57 receives the general routing information 20 or revised general routing information 63 the revision unit 56 outputs and the layout data 18 after the macro cell placement the placement unit 12 outputs. Then, in accordance with the general routing information 20 or revised general routing information 63, the detailed routing unit 57 decides the final routing (detailed routing) of the individual connections. The detailed routing unit 57 outputs the layout data 9 after the placement and routing.

Next, the operation of the present embodiment 2 will be described.

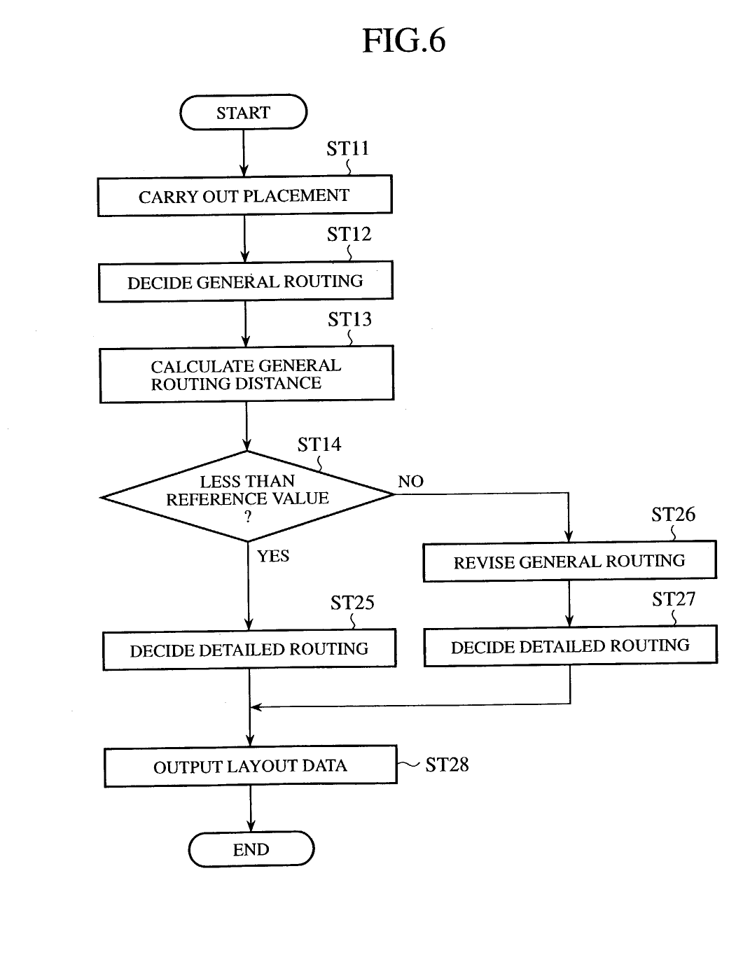

FIG. 6 is a flowchart illustrating the operation of the embodiment 2 of the automatic placement and routing system.

First, as in the foregoing embodiment 1, the present embodiment 2 carries out the placement of the memory macro cells and fuse macro cells (step ST11).

Subsequently, as in the foregoing embodiment 1, it decides the general routing of the individual connections (step ST12).

Subsequently, as in the foregoing embodiment 1, it calculates the sum total of the distances of the individual connections along the general routing (step ST13).

Subsequently, as in the foregoing embodiment 1, it makes a decision as to whether the sum total of the distances of the individual connections along the general routing is less than the reference value (step ST14).

Subsequently, the revision unit 56 receives the decision information 22 the decision unit 15 outputs and the general routing information 20 the general routing unit 13 outputs.

When the sum total of the distances of the individual connections along the general routing is less than the reference value, the revision unit 56 does not revise the general routing of the individual connections. Subsequently, the detailed routing unit 57 receives the general routing information 20 the revision unit 56 outputs and the layout data 18 after the macro cell placement the placement unit 12 outputs, and decides the final routing (detailed routing) of the individual connections in accordance with the general routing information 20 (step ST25).

In contrast, when the sum total of the distances of the individual connections along the general routing is greater than the reference value, the revision unit 56 revises the general routing of the specified connection (step ST26). The revision of the general routing is carried out by exchanging the terminals of the fuse macro cell to which the terminals of the memory macro cell are connected. The exchange of the terminals of the fuse macro cell is made on a terminal by terminal basis. The exchange of the terminals of the fuse macro cell is carried out such that the sum total of the distances of the individual connections along the general routing becomes less than the reference value. Subsequently, the detailed routing unit 57 receives the revised general routing information 63 the revision unit 56 outputs and the layout data 18 after the macro cell placement the placement unit 12 outputs, and decides the final routing (detailed routing) of the individual connections in accordance with the revised general routing information 63 (step ST27).

Subsequently, the detailed routing unit 57 outputs the layout data 9 after the placement and routing (step ST28).

FIG. 7 is a layout diagram illustrating a semiconductor circuit designed using the embodiment 2 of the automatic placement and routing system.

In the layout diagram as shown in FIG. 7, first and second memory macro cells 71 and 72 are placed oppositely to a fuse macro cell 74. In addition, a third memory macro cell 73 is placed on the opposite side of the fuse macro cell 74 with respect to the second memory macro cell 72.

On the sides of the first to third memory macro cells 71-73 closest to the fuse macro cell 74, there are provided terminals for connecting them to the terminals of the fuse macro cell 34. On the other hand, on the side of fuse macro cell 74 closest to the first to third memory macro cells 71-73, there are provided terminals for connecting it to the terminals of the first to third memory macro cells 71-73. The terminals of the fuse macro cell 74 are shown as first to third terminal sets 75-77 that are separated apart on a memory macro cell by memory macro cell basis from the left-hand side.

The terminals of the first memory macro cell 71 are connected to the terminals of the first terminal set 75 of the fuse macro cell 74 via a first wiring bundle 78 consisting of five wires. The terminals of the second memory macro cell 72 are connected to the terminals of the second terminal set 76 of the fuse macro cell 74 via a second wiring bundle 79 consisting of three wires, and to the terminals of the third terminal set 77 of the fuse macro cell 74 via a third wiring bundle 80 consisting of two wires. The terminals of the third memory macro cell 73 are connected to the terminals of the second terminal set 76 of the fuse macro cell 74 via a fourth wiring bundle 81 consisting of two wires, and to the terminals of the third terminal set 77 of the fuse macro cell 74 via a fifth wiring bundle 82 consisting of three wires.

In contrast, in a layout diagram (not shown) of a semiconductor circuit designed by a conventional automatic placement and routing system, for example, the terminals of the first memory macro cell 71 are connected to the terminals of the first terminal sets 75 of the fuse macro cell 74 via a wiring bundle consisting of five wires, the terminals of the second memory macro cell 72 are connected to the terminals of the second terminal sets 76 of the fuse macro cell 74 via a wiring bundle consisting of five wires, and the terminals of the third memory macro cell 73 are connected to the terminals of the third terminal sets 77 of the fuse macro cell 74 via a wiring bundle consisting of five wires.

In the present embodiment 2, the terminals of the fuse macro cell 74, to which the terminals of the first to third memory macro cells 71-73 are connected, are exchanged on a terminal by terminal basis so that the sum total of the distances of the individual connections along the general routing becomes less than the reference value. In the conventional case, however, the connections between the first to third memory macro cells 71-73 and the fuse macro cell 74 are determined in advance so that the terminals of the first to third memory macro cells 71-73 are connected to the terminals of the fuse macro cell 74 on a memory macro cell by memory macro cell basis. Accordingly, the embodiment 2 is smaller than the conventional example in the wiring congestion between the first to third memory macro cells 71-73 and the fuse macro cell 74.

As described above, the embodiment 2 calculates the sum total of the distances of the individual connections along the general routing, and revises the general routing such that the sum total becomes less than the reference value. Consequently, it makes it possible to design a semiconductor circuit with a smaller layout size.

Although the present embodiment 1 handles the case where the revision of the general routing is carried out once to make the sum total of the distances of the individual connections along the general routing less than the reference value, this is not essential. For example, it can be configured such that the sum total of the distances of the individual connections along the general routing is made less than the reference value by carrying out the revision of the general routing a plurality of times.

### Embodiment 3

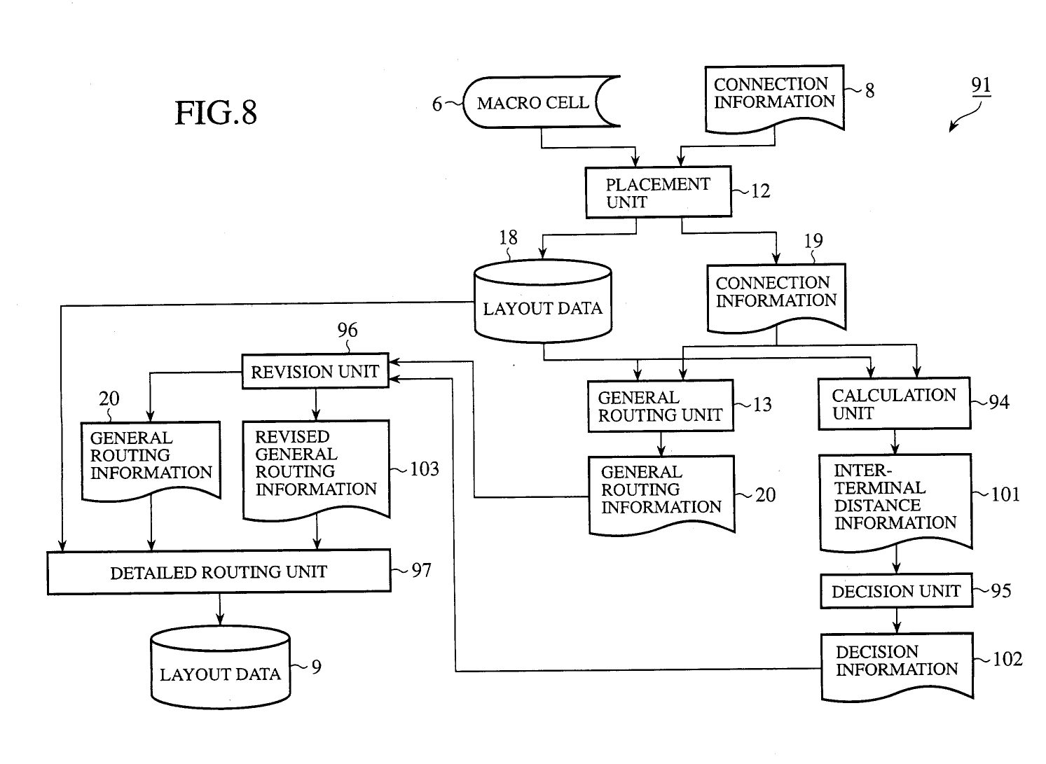

FIG. 8 is a block diagram showing a configuration of an embodiment 3 of the automatic placement and routing system in accordance with the present invention.

The automatic placement and routing system 91 of the embodiment 3 includes the placement unit 12, the general routing unit 13, a calculation unit 94, a decision unit 95, a revision unit 96, and a detailed routing unit 97.

The placement unit 12 and general routing unit 13 are the same as those of the foregoing embodiment 1.

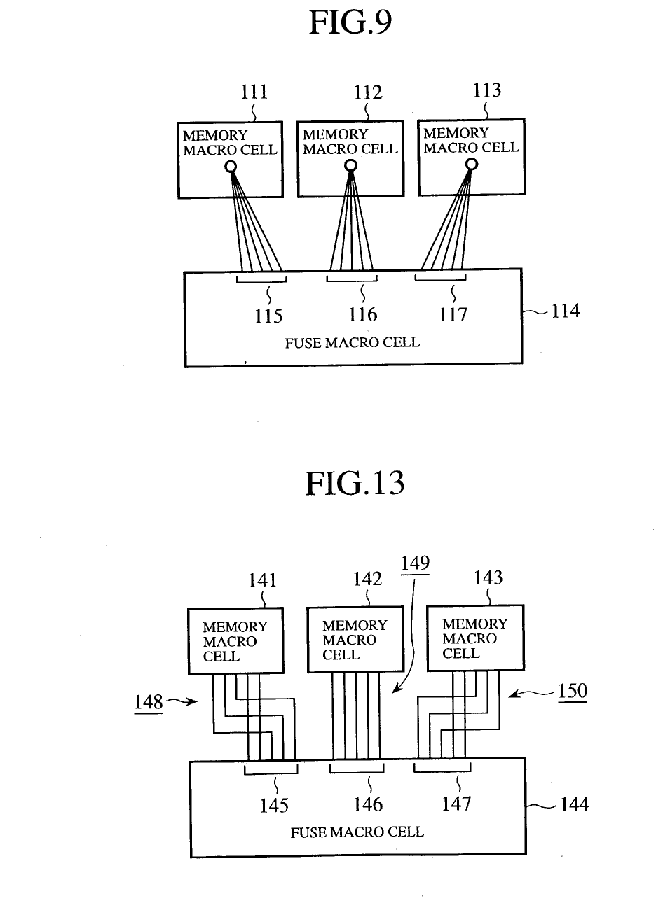

The calculation unit 94 receives the layout data 18 and connection information 19 after the macro cell placement the placement unit 12 outputs. Then, assuming that the terminals of the memory macro cells to be connected to the fuse macro cell are located at the centers of the memory macro cells, the calculation unit 94 calculates the sum total of the distances between the terminals of the memory macro cells and the terminals of the fuse macro cell (called “inter-terminal distances” from now on) of the individual connections. FIG. 9 illustrates a case in which the terminals of the memory macro cells are assumed to be located at the centers of the memory macro cells. In FIG. 9, the terminals of a first memory macro cell 111 are connected to a first terminal set 115 of the fuse macro cell 114, the terminals of a second memory macro cell 112 are connected to a second terminal set 116 of the fuse macro cell 114, and the terminals of a third memory macro cell 113 are connected to a third terminal set 117 of the fuse macro cell 114.

The decision unit 95 receives the inter-terminal distance information 101 the calculation unit 94 outputs. Then, it makes a decision as to whether the sum total of the inter-terminal distances of the individual connections is less than the reference value the decision unit 95 holds. The decision is made by comparing the inter-terminal distance information 101 with the reference value. The decision unit 95 outputs information about the decision result (called “decision information” from now on) 102.

The revision unit 96 receives the decision information 102 the decision unit 95 outputs and the general routing information 20 the general routing unit 13 outputs. Then, when the sum total of the inter-terminal distances of the individual connections is less than the reference value, the revision unit 96 outputs the general routing information 20 fed from the general routing unit 13 without revising the general routing of the individual connections. In contrast, when the sum total is greater than the reference value, it revises the general routing of a specified connection, and outputs information about the general routing after the revision (called “revised general routing information”) 103. The revision of the general routing is carried out by exchanging the terminals of the fuse macro cell to which the terminals of the memory macro cells are connected. The exchange of the terminals of the fuse macro cell is carried out on a memory macro cell by memory macro cell basis. The exchange of the terminals of the fuse macro cell is carried out in such a manner that the sum total of the inter-terminal distances of the individual connections becomes less than the reference value.

The detailed routing unit 97 receives the general routing information 20 or revised general routing information 103 the revision unit 96 outputs and the layout data 18 after the macro cell placement the placement unit 12 outputs. Then, it decides the final routing (detailed routing) of the individual connections in accordance with the general routing information 20 or revised general routing information 103. The detailed routing unit 97 outputs the layout data 9 after the placement and routing.

Next, the operation of the present embodiment 3 will be described.

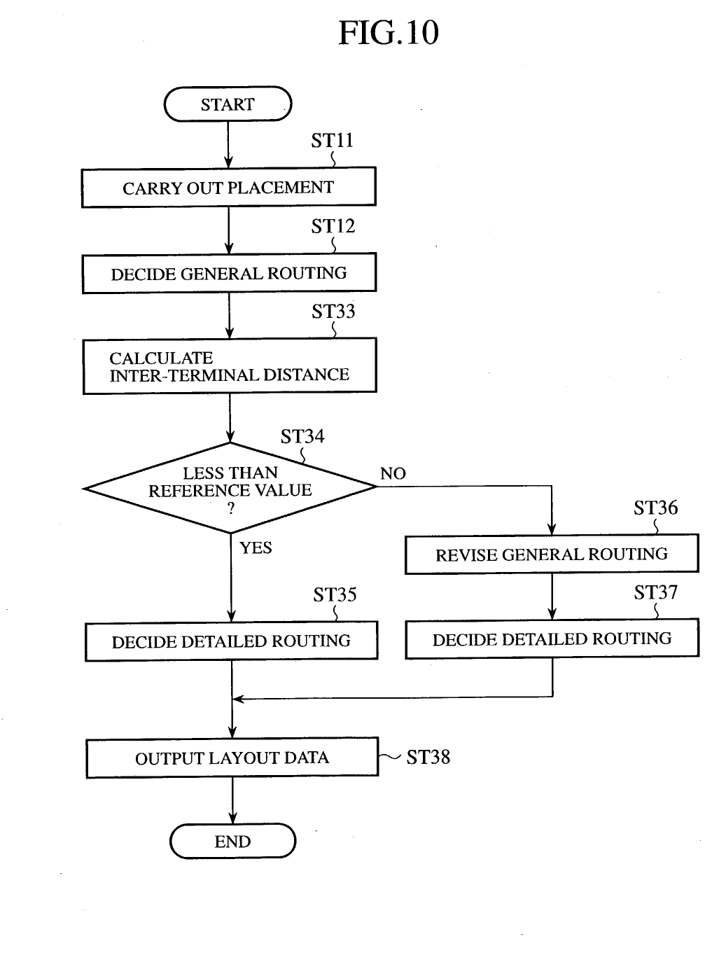

FIG. 10 is a flowchart illustrating the operation of the embodiment 3 of the automatic placement and routing system.

First, as in the foregoing embodiment 1, the present embodiment 3 carries out the placement of the memory macro cells and fuse macro cells (step ST11).

Subsequently, as in the foregoing embodiment 1, it decides the general routing of the individual connections (step ST12).

Subsequently, the calculation unit 94 receives the layout data 18 and connection information 19 after the macro cell placement the placement unit 12 outputs, and calculates the sum total of the inter-terminal distances of the individual connections under the assumption that the terminals of the memory macro cells for connecting them to the fuse macro cell are located at the centers of the memory macro cells (step ST33).

Subsequently, the decision unit 95 receives the inter-terminal distance information 101 the calculation unit 94 outputs, and makes a decision as to whether the sum total of the inter-terminal distances of the individual connections is less than the reference value (step ST34). The decision is made by comparing the inter-terminal distance information 101 with the reference value.

Subsequently, the revision unit 96 receives the decision information 102 the decision unit 95 outputs and the general routing information 20 the general routing unit 13 outputs.

When the sum total of the inter-terminal distances of the individual connections becomes less than the reference value, the revision unit 96 does not revise the general routing of the individual connections. Subsequently, the detailed routing unit 97 receives the general routing information 20 the revision unit 96 outputs and the layout data 18 after the macro cell placement the placement unit 12 outputs, and decides the final routing (detailed routing) of the individual connections in accordance with the general routing information 20 (step ST35)

In contrast, when the sum total of the inter-terminal distances of the individual connections is greater than the reference value, the revision unit 96 revises the general routing of the specified connection (step ST36). The revision of the general routing is carried out by exchanging the terminals of the fuse macro cell to which the terminals of the memory macro cells are connected. The exchange of the terminals of the fuse macro cell is made on a memory macro cell by memory macro cell basis. The exchange of the terminals of the fuse macro cell is carried out in such a manner that the sum total of the inter-terminal distances of the individual connections becomes less than the reference value. Subsequently, the detailed routing unit 97 receives the revised general routing information 103 the revision unit 96 outputs and the layout data 18 after the macro cell placement the placement unit 12 outputs, and decides the complete routing (detailed routing) of the individual connections in accordance with the revised general routing information 103 (step ST37).

Subsequently, the detailed routing unit 97 outputs the layout data 9 after the placement and routing (step ST38).

As described above, the present embodiment 3 calculates the sum total of the inter-terminal distances of the individual connections under the assumption that the terminals of the memory macro cells are located at the centers of the memory macro cells, and revises the general routing in such a manner that the sum total becomes less than the reference value. Thus, it can reduce the wiring congestion between the memory macro cells and fuse macro cell by setting the reference value at an appropriate value. Consequently, it makes it possible to design a semiconductor circuit with a smaller layout size.

In addition, since the present embodiment 3 calculates the sum total of the inter-terminal distances of the individual connections under the assumption that the terminals of the memory macro cells are located at the centers of the memory macro cells, and revises the general routing in accordance with the calculation result, it can reduce the processing time of the revision of the general routing as compared with the embodiments 1 and 2 that calculate the sum total of the distances of the individual connections along the general routing, and revise the general routing in accordance with the calculation result.

Although the present embodiment 3 handles the case where the revision of the general routing is carried out once to make the sum total of the inter-terminal distances of the individual connections less than the reference value, this is not essential. For example, it can be configured such that the sum total of the inter-terminal distances of the individual connections is made less than the reference value by carrying out the revision of the general routing a plurality of times.

In addition, although the embodiment 3 exchanges the terminals of the fuse macro cell on a memory macro cell by memory macro cell basis, it can be configured such that the it exchanges the terminals on a terminal by terminal basis.

### Embodiment 4

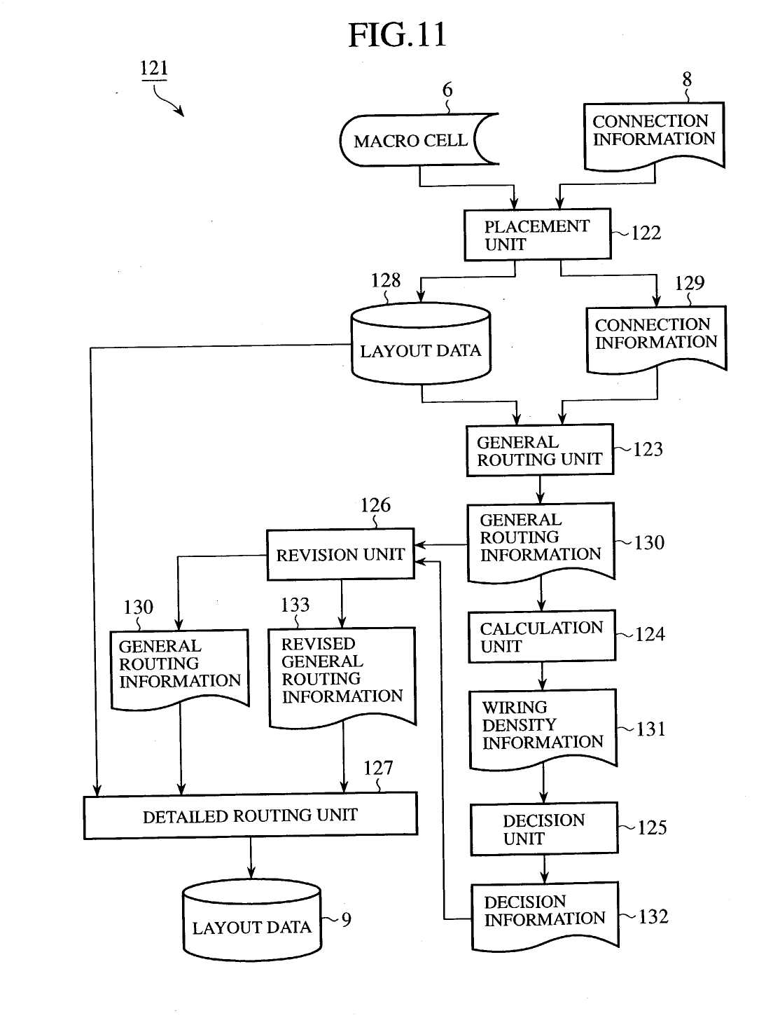

FIG. 11 is a block diagram showing a configuration of an embodiment 4 of the automatic placement and routing system in accordance with the present invention.

The embodiment 4 of the automatic placement and routing system 121 includes a placement unit 122, a general routing unit 123, a calculation unit 124, a decision unit 125, a revision unit 126 and a detailed routing unit 127.

Just as the placement unit 12 of the embodiment 1, receiving the connection information 8 the analyzer 3 outputs and the macro cells 6 the input unit 2 reads, the placement unit 122 carries out placement of the memory macro cells and fuse macro cell. The memory macro cells and fuse macro cell are placed in such a manner that their opposing sides become parallel.

The general routing unit 123 receives the layout data 128 and connection information 129 after the macro cell placement the placement unit 122 outputs, and decides general routing of the individual connections just as the general routing unit 13 of the embodiment 1.

The calculation unit 124 receives the general routing information 130 the general routing unit 123 outputs. Then, it calculates from the general routing information 130 the density of wiring components parallel to the opposing sides of the memory macro cells and fuse macro cell between the memory macro cells and fuse macro cell (called “parallel wiring components” from now on). The calculation unit 124 outputs the information about the density of the parallel wiring components (called “wiring density information” from now on) 131.

The decision unit 125 receives the wiring density information 131 the calculation unit 124 outputs. Then, it makes a decision as to whether the density of the parallel wiring components is less than a reference value held by the decision unit 125. By setting the reference value at an appropriate value, the decision unit 125 can make a decision as to whether the density of the parallel wiring components is a minimum. The decision is made by comparing the wiring density information 131 with the reference value. The decision unit 125 outputs information about the decision result (called “decision information” from now on) 132.

The revision unit 126 receives the decision information 132 the decision unit 125 outputs and the general routing information 130 the general routing unit 123 outputs. Then, when the density of the parallel wiring components is less than the reference value, it outputs the general routing information 130 fed from the general routing unit 123 without revising the general routing of the individual connections. In contrast, when the density of the parallel wiring components is greater than the reference value, it revises the general routing of a specified connection, and outputs information about the general routing after the revision (called “revised general routing information”) 133. The revision of the general routing is carried out by exchanging the terminals of the fuse macro cell to which the terminals of the memory macro cells are connected. The exchange of the terminals of the fuse macro cell is carried out on a terminal by terminal basis within the same memory macro cell. The exchange of the terminals of the fuse macro cell is carried out in such a manner that the density of the parallel wiring components becomes less than the reference value.

The detailed routing unit 127 receives the general routing information 130 or revised general routing information 133 the revision unit 126 outputs and the layout data 128 after the macro cell placement the placement unit 122 outputs. Then, it decides the final routing (detailed routing) of the individual connections in accordance with the general routing information 130 or revised general routing information 133. The detailed routing unit 127 outputs the layout data 9 after the placement and routing.

Next, the operation of the present embodiment 4 will be described.

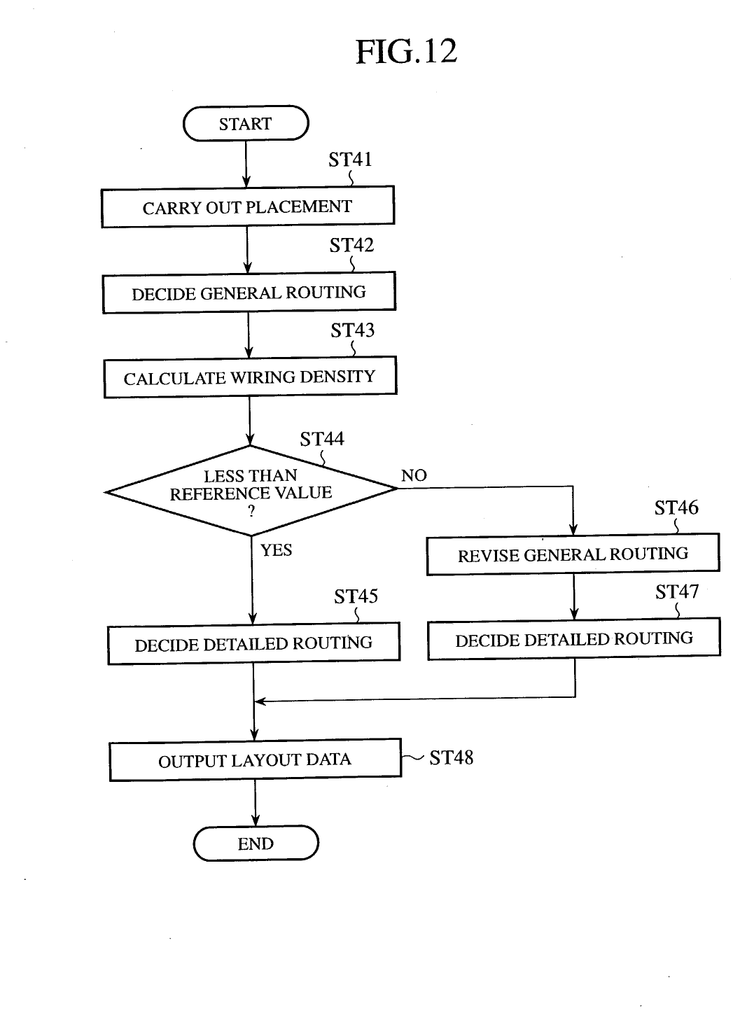

FIG. 12 is a flowchart illustrating the operation of the embodiment 4 of the automatic placement and routing system.

First, as in the embodiment 1, the placement unit 122 receives the connection information 8 the analyzer 3 outputs and the macro cells 6 the input unit 2 reads, and carries out placement of the memory macro cells and fuse macro cell in accordance with the connection information 8 (step ST41). The memory macro cells and fuse macro cell are placed in such a manner that their opposing sides become parallel.

Subsequently, as in the foregoing embodiment 1, the general routing unit 123 receives the layout data 128 and connection information 129 after the macro cell placement the placement unit 122 outputs, and decides the general routing of the individual connections (step ST42).

Subsequently, the calculation unit 124 receives the general routing information 130 the general routing unit 123 outputs, and calculates the density of the parallel wiring components from the general routing information 130 (step ST43).

Subsequently, the decision unit 125 receives the wiring density information 131 the calculation unit 124 outputs, and makes a decision as to whether the density of the parallel wiring components is less than the reference value (step ST44). The decision is made by comparing the wiring density information 131 with the reference value.

Subsequently, the revision unit 126 receives the decision information 132 the decision unit 125 outputs and the general routing information 130 the general routing unit 123 outputs.

When the density of the parallel wiring components is less than the reference value, the revision unit 126 does not revise the general routing of the individual connections. Subsequently, the detailed routing unit 127 receives the general routing information 130 the revision unit 126 outputs and the layout data 128 after the macro cell placement the placement unit 122 outputs, and decides the final routing (detailed routing) of the individual connections in accordance with the general routing information 130 (step ST45).

In contrast, when the density of the parallel wiring components is greater than the reference value, the revision unit 126 revises the general routing of the specified connection (step ST46). The revision of the general routing is carried out by exchanging the terminals of the fuse macro cell to which the terminals of the memory macro cells are connected. The exchange of the terminals of the fuse macro cell is made on a terminal by terminal basis within the same memory macro cell. The exchange of the terminals of the fuse macro cell is carried out in such a manner that the density of the parallel wiring components becomes less than the reference value. Subsequently, the detailed routing unit 127 receives the revised general routing information 133 the revision unit 126 outputs and the layout data 128 after the macro cell placement the placement unit 122 outputs, and decides the final routing (detailed routing) of the individual connections in accordance with the revised general routing information 133 (step ST47).

Subsequently, the detailed routing unit 127 outputs the layout data 9 after the placement and routing (step ST48).

FIG. 13 is a layout diagram illustrating a semiconductor circuit designed using the embodiment 4 of the automatic placement and routing system.

In the layout diagram as shown in FIG. 13, first to third memory macro cells 141-143 are placed oppositely to a fuse macro cell 144. The first to third memory macro cells 141-143 and fuse macro cell 144 are placed in such a manner that their opposing sides become parallel.

On the sides of the first to third memory macro cells 141-143 closest to the fuse macro cell 144, there are provided terminals for connecting them to the terminals of the fuse macro cell 144. On the other hand, on the side of the fuse macro cell 144 closest to the first to third memory macro cells 141-143, there are provided terminals for connecting it to the terminals of the first to third memory macro cells 141-143. The terminals of the fuse macro cell 144 are shown as first to third terminal sets 145-147 that are separated apart on a memory macro cell by memory macro cell basis from the left-hand side. The terminals of the first to third memory macro cells 141-143 are connected to the terminals of the fuse macro cell 144 on a memory macro cell by memory macro cell basis.

The terminals of the first memory macro cell 141 are connected to the terminals of the first terminal set 145 of the fuse macro cell 144 via a first wiring bundle 148 consisting of five wires. The terminals of the second memory macro cell 142 are connected to the terminals of the second terminal set 146 of the fuse macro cell 144 via a second wiring bundle 149 consisting of five wires. The terminals of the third memory macro cell 143 are connected to the terminals of the third terminal set 147 of the fuse macro cell 144 via a third wiring bundle 150 consisting of five wires. Two of the five wires of the first and third wiring bundles 148 and 150 include only the wiring components perpendicular to the opposing sides of the first and third memory macro cells 141 and 143 and the fuse macro cell 144. The remaining three wires include both the wiring components perpendicular to and parallel to the opposing sides of the first and third memory macro cells 141 and 143 and the fuse macro cell 144.

In contrast, in a layout diagram (not shown) of a semiconductor circuit designed by a conventional automatic placement and routing system, the five wires in the wiring bundle which connects the terminals of the first memory macro cell 141 and the terminals of the first terminal sets 145 of the fuse macro cell 144, and the five wires in the wiring bundle which connects the terminals of the third memory macro cell 143 and the terminals of the third terminal sets 147 of the fuse macro cell 144, are parallel to each other, and include both the wiring components perpendicular to and parallel to the opposing sides of the first and third memory macro cells 141 and 143 and the fuse macro cell 144.

In the present embodiment 4, the terminals of the fuse macro cell 144, to which the terminals of the first to third memory macro cells 141-143 are connected, are exchanged on a terminal by terminal basis within the same memory macro cell so that the density of the parallel wiring components becomes less than the reference value. In the conventional case, however, the connections between the first to third memory macro cells 141-143 and the fuse macro cell 144 are determined in advance. Accordingly, the embodiment 4 is smaller than the conventional example in the wiring congestion between the first to third memory macro cells 141-143 and the fuse macro cell 144.

As described above, the present embodiment 4 calculates the density of the parallel wiring components, and revises the general routing in such a manner that the density of the parallel wiring components becomes less than the reference value. Thus, it can reduce the wiring congestion between the memory macro cells and fuse macro cell by setting the reference value at an appropriate value. Consequently, it makes it possible to design a semiconductor circuit with a smaller layout size.

Although the present embodiment 4 handles the case where the revision of the general routing is carried out once to make the density of the parallel wiring components less than the reference value, this is not essential. For example, it can be configured such that the density of the parallel wiring components is made less than the reference value by carrying out the revision of the general routing a plurality of times.

### Embodiment 5

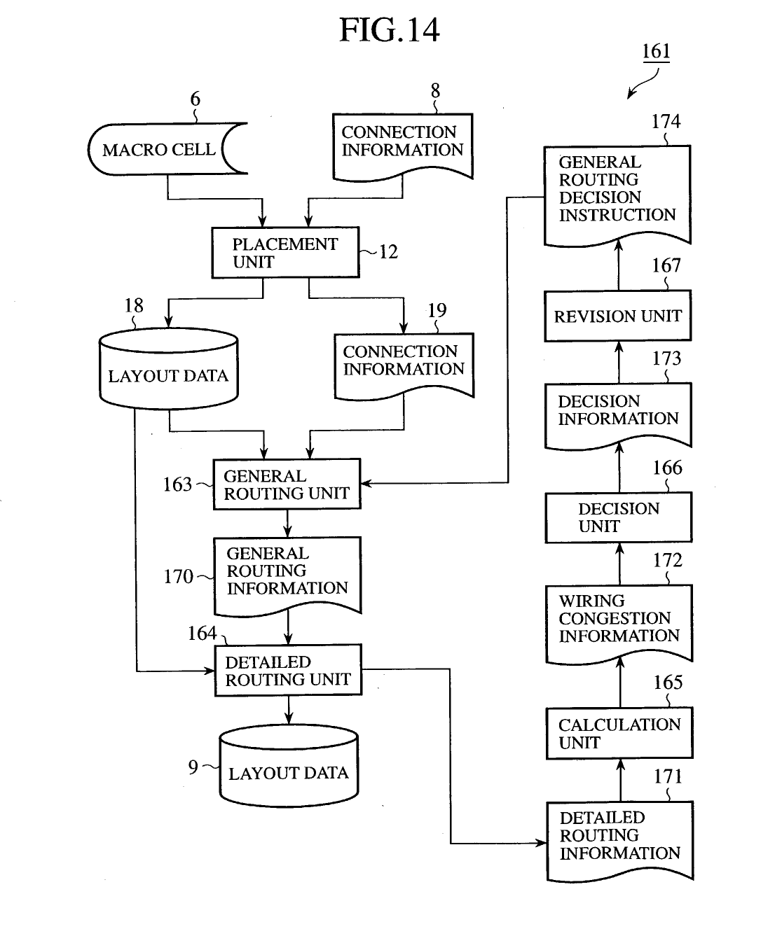

FIG. 14 is a block diagram showing a configuration of an embodiment 5 of the automatic placement and routing system in accordance with the present invention.

The embodiment 5 of the automatic placement and routing system 161 includes the placement unit 12, a general routing unit 163, a detailed routing unit 164, a calculation unit 165, a decision unit 166, and a revision unit 167.

The placement unit 12 is the same as that of the foregoing embodiment 1.

The general routing unit 163 receives the layout data 18 and connection information 19 after the macro cell placement the placement unit 12 outputs. Then, it sequentially decides general routing of the individual connections in accordance with the connection information 19. After receiving an instruction (general routing decision instruction) 174 to decide the general routing of the next connection from the revision unit 167, the general routing unit 163 decides the general routing of the next connection. The general routing unit 163 outputs resultant information about the general routing (called “general routing information” from now on) 170 every time it decides the general routing of a single connection.

The detailed routing unit 164 receives the general routing information 170 the general routing unit 163 outputs and the layout data 18 after the macro cell placement the placement unit 12 outputs. Then, every time it receives the general routing information 170, it decides the final routing (detailed routing) of the connection associated with the general routing information 170 in accordance with the general routing information 170. The detailed routing unit 164 makes a decision as to whether the detailed routing of all the connections has been decided or not. If not, the detailed routing unit 164 outputs the resultant information about the detailed routing (called “detailed routing information” from now on) 171 of the connections whose detailed routing has already been decided. If the detailed routing of all the connections has been decided, the detailed routing unit 164 outputs the layout data 9 after the placement and routing.

The calculation unit 165 receives the detailed routing information 171 the detailed routing unit 164 outputs. Then, every time it receives the detailed routing information 171, it calculates the wiring congestion between the memory macro cells and fuse macro cell from the detailed routing information 171. Every time it calculates the wiring congestion, the calculation unit 165 outputs information about the-wiring congestion (called “wiring congestion information” from now on) 172.

The decision unit 166 receives the wiring congestion information 172 the calculation unit 165 outputs. Every time it receives the wiring congestion information 172, the decision unit 166 makes a decision as to whether the wiring congestion is less than a reference value held by the decision unit 166. By setting the reference value at an appropriate value, the decision unit 166 can make a decision as to whether the wiring congestion is heavy or not. The heavy wiring congestion means that the detailed routing of the next connection will pass through the wiring congestion section, in which the detailed routing of two connections can overlap, or the detailed routing covers an area on the same layer at minimum intervals. The decision is made by comparing the wiring congestion information 172 with the reference value. Every time it makes a decision, the decision unit 166 outputs information about the decision result (called “decision information” from now on) 173.

The revision unit 167 receives the decision information 173 the decision unit 166 outputs. Then, when the wiring congestion is less than the reference value, it does not revise the general routing of the connection which has already been decided, and supplies the general routing unit 163 with the instruction (general routing decision instruction) 174 to decide the general routing of the next connection. In contrast, when the wiring congestion is greater than the reference value, the revision unit 167 revises the general routing of the specified connection which has already been decided, revises its detailed routing in accordance with the revision, and supplies the general routing decision instruction 174 to the general routing unit 163. The revision of the general routing is made by exchanging the terminals of the fuse macro cell to which the terminals of the memory macro cells are connected. The exchange of the terminals of the fuse macro cell is carried out in such a manner that the wiring congestion becomes less than the reference value.

Next, the operation of the present embodiment 5 will be described.

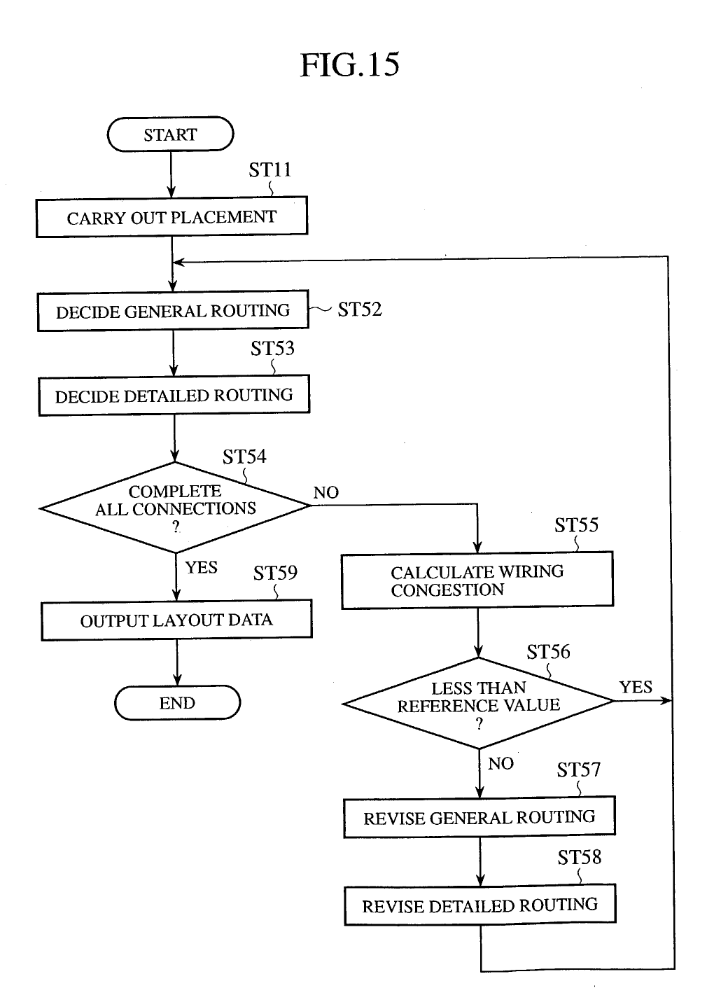

FIG. 15 is a flowchart illustrating the operation of the embodiment 5 of the automatic placement and routing system.

First, the placement unit 12 carries out placement of the memory macro cells and fuse macro cells as in the foregoing embodiment 1 (step ST11).

Subsequently, the general routing unit 163 receives the layout data 18 and connection information 19 after the macro cell placement the placement unit 12 outputs, and decides the general routing of a given connection in accordance with the connection information 19 (step ST52).

Subsequently, the detailed routing unit 164 receives the general routing information 170 the general routing unit 163 outputs and the layout data 18 after the macro cell placement the placement unit 12 outputs, and decides the final routing (detailed routing) of the connection in accordance with the general routing information 170 (step ST53).

Subsequently, the detailed routing unit 164 makes a decision as to whether the detailed routing of all the connections has been decided or not (step ST54).

If the detailed routing of some connection has not yet been decided, the calculation unit 165 receives the detailed routing information 171 the detailed routing unit 164 outputs, and calculates the wiring congestion between the memory macro cells and fuse macro cell from the detailed routing information 171 (step ST55).

Subsequently, the decision unit 166 receives the wiring congestion information 172 the calculation unit 165 outputs, and makes a decision as to whether the wiring congestion is less than the reference value (step ST56). The decision is made by comparing the wiring congestion information 172 with the reference value.

Subsequently, the revision unit 167 receives the decision information 173 the decision unit 166 outputs.

When the wiring congestion is less than the reference value, the revision unit 167 does not revise the general routing of the connection whose general routing has already been decided. Subsequently, the general routing unit 163, receiving the general routing decision instruction 174 from the revision unit 167, decides the general routing of the next connection (step ST52).

In contrast, when the wiring congestion is greater than the reference value, the revision unit 167 revises the general routing of the specified connection among the connections whose general routing has already been decided (step ST57), and revises the detailed routing in accordance with the revision (step ST58) The revision of the general routing is carried out by exchanging the terminals of the fuse macro cell to which the terminals of the memory macro cells are connected. The exchange of the terminals of the fuse macro cell is made in such a manner that the wiring congestion becomes less than the reference value. Subsequently, the general routing unit 163 receives the general routing decision instruction 174 from the revision unit 167, and decides the general routing of the next connection (step ST52).

Once the detailed routing of all the connections has been decided, the detailed routing unit 164 outputs the layout data 9 after the placement and routing (step ST59).

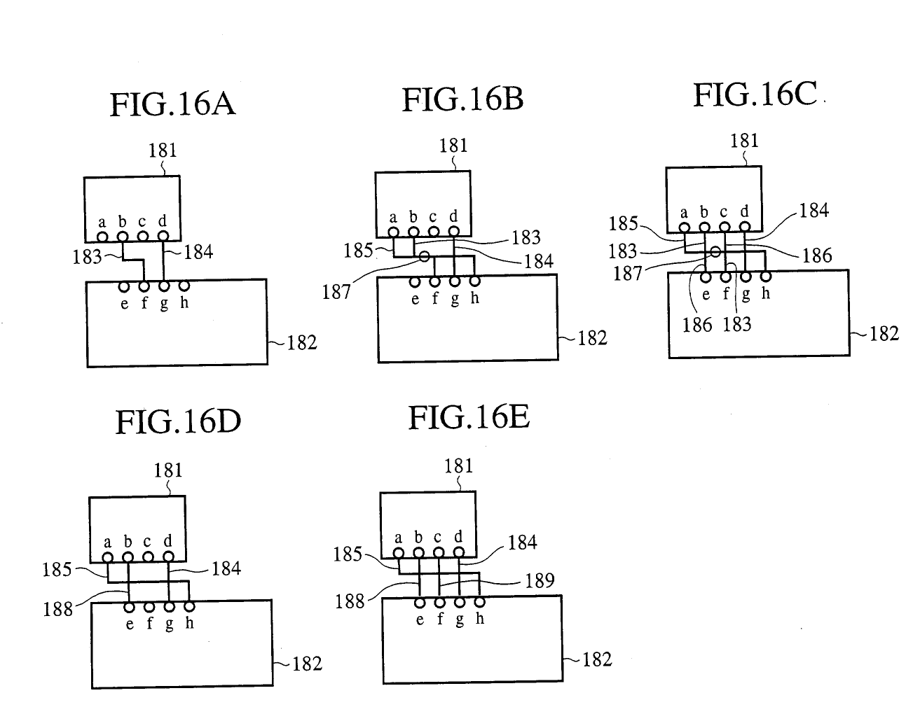

FIG. 16 is a diagram sequentially illustrating the layouts of the semiconductor circuit designed by using the embodiment 5 of the automatic placement and routing system. FIG. 16 illustrates an example which revises the general routing of a specified connection to prevent the detailed routing of the next connection from passing through the wiring congestion section at which the detailed routing of two connections overlaps, and revises the detailed routing in accordance with the revision, thereby designing the semiconductor circuit with a reduced wiring congestion.

From FIG. 16(a) to FIG. 16(e), a memory macro cell 181 is placed oppositely to a fuse macro cell 182. On the side of the memory macro cell 181 closest to the fuse macro cell 182, there are provided terminals a-d for making a connection with the fuse macro cell 182. On the side of the fuse macro cell 182 closest to the memory macro cell 181, there are provided terminals e-h for making a connection with the memory macro cell 181.

As illustrated in FIG. 16(a), the detailed routing 183 of a first connection connects the terminal b of the memory macro cell 181 to the terminal f of the fuse macro cell 182, and the detailed routing 184 of a second connection connects the terminal d of the memory macro cell 181 to the terminal g of the fuse macro cell 182.

As illustrated in FIG. 16(b), the detailed routing 185 of a third connection connects the terminal a of the memory macro cell 181 to the terminal h of the fuse macro cell 182.

Deciding the detailed routing of a fourth connection in the condition of FIG. 16(b) will cause the detailed routing 186 of the fourth connection to connect the terminal c of the memory macro cell 181 to the terminal e of the fuse macro cell 182 with passing through a wiring congestion section 187 at which the detailed routing 183 overlaps with the detailed routing 185 as illustrated in FIG. 16(c). Considering this, the revision of the general routing 183 of the first connection is made in such a manner that the terminal b of the memory macro cell 181 is connected to the terminal e of the fuse macro cell 182 in the condition of FIG. 16(b). Then, the detailed routing is revised in accordance with the revision of the first connection.

As illustrated in FIG. 16(d), the revised detailed routing 188 of the first connection connects the terminal b of the memory macro cell 181 to the terminal e of the fuse macro cell 182.

Deciding the detailed routing of the fourth connection in the condition of FIG. 16(d) causes the detailed routing 189 of the fourth connection to connect the terminal c of the memory macro cell 181 to the terminal f of the fuse macro cell 182 with preventing it from passing through the wiring congestion section as illustrated in FIG. 16(e). Consequently, the wiring congestion is less heavy in the condition of FIG. 16(e) than that of FIG. 16(c).

As described above, the present embodiment 5 calculates the wiring congestion every time the detailed routing of each connection is decided, revises the general routing such that the wiring congestion becomes less than the reference value, and revises the detailed routing in accordance with the revision. Accordingly, setting the reference value at an appropriate value enables the reduction in the wiring congestion between the memory macro cells and fuse macro cell. This makes it possible to design a semiconductor circuit with a small layout size.

### Embodiment 6

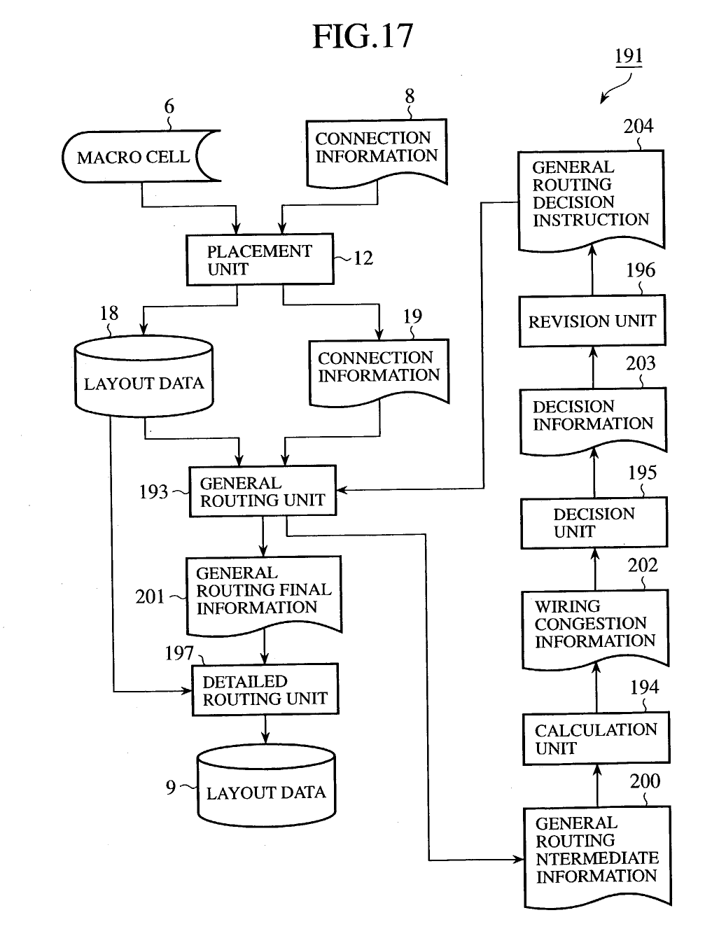

FIG. 17 is a block diagram showing a configuration of an embodiment 6 of the automatic placement and routing system in accordance with the present invention.

The embodiment 6 of the automatic placement and routing system 191 includes the placement unit 12, a general routing unit 193, a calculation unit 194, a decision unit 195, a revision unit 196 and a detailed routing unit 197.

The placement unit 12 is the same as that of the foregoing embodiment 1.

The general routing unit 193 receives the layout data 18 and connection information 19 after the macro cell placement the placement unit 12 outputs. Then, it sequentially decides general routing of the individual connections in accordance with the connection information 19. After receiving an instruction (general routing decision instruction) 204 to decide the general routing of the next connection from the revision unit 196, the general routing unit 193 decides the general routing of the next connection. Then, the general routing unit 193 makes a decision as to whether the general routing of all the connections has already been decided. If not, the general routing unit 193 outputs the resultant information about the general routing (called “general routing intermediate information” from now on) 200 of the connections whose general routing has already been decided. If the general routing of all the connections has been decided, the general routing unit 193 outputs the resultant information about the general routing of all the connections (called “general routing final information” from now on) 201.

The calculation unit 194 receives the general routing intermediate information 200 the general routing unit 193 outputs. Then, every time it receives the general routing intermediate information 200, it calculates the wiring congestion between the memory macro cells and fuse macro cell from the general routing intermediate information 200. Every time it calculates the wiring congestion, the calculation unit 194 outputs information about the wiring congestion (called “wiring congestion information” from now on) 202.

The decision unit 195 receives the wiring congestion information 202 the calculation unit 194 outputs. Every time it receives the wiring congestion information 202, the decision unit 195 makes a decision as to whether the wiring congestion is less than the reference value the decision unit 195 holds. By setting the reference value at an appropriate value, the decision unit 195 can make a decision as to whether the wiring congestion is heavy or not. The heavy wiring congestion means that the general routing of the next connection will pass through the wiring congestion section, at which the general routing of two connections can overlap, or the general routing covers an area on the same layer at minimum intervals. The decision is made by comparing the wiring congestion information 202 with the reference value. Every time it makes a decision, the decision unit 195 outputs information about the decision result (called “decision information” from now on) 203.

The revision unit 196 receives the decision information 203 the decision unit 195 outputs. Then, when the wiring congestion is less than the reference value, it does not revise the general routing of the connections which has already been decided, and supplies the general routing unit 193 with the instruction (general routing decision instruction) 204 to decide the general routing of the next connection. In contrast, when the wiring congestion is greater than the reference value, the revision unit 196 revises the general routing of a specified connection among the connections whose general routing has already been decided, and supplies the general routing decision instruction 204 to the general routing unit 193. The revision of the general routing is made by exchanging the terminals of the fuse macro cell to which the terminals of the memory macro cells are connected. The exchange of the terminals of the fuse macro cell is carried out in such a manner that the wiring congestion becomes less than the reference value.

The detailed routing unit 197 receives the general routing final information 201 the general routing unit 193 outputs, and the layout data 18 after the macro cell placement the placement unit 12 outputs. Then, it decides the final routing (detailed routing) of the individual connections in accordance with the general routing final information 201. The detailed routing unit 197 outputs the layout data 9 after the placement and routing.

Next, the operation of the present embodiment 6 will be described.

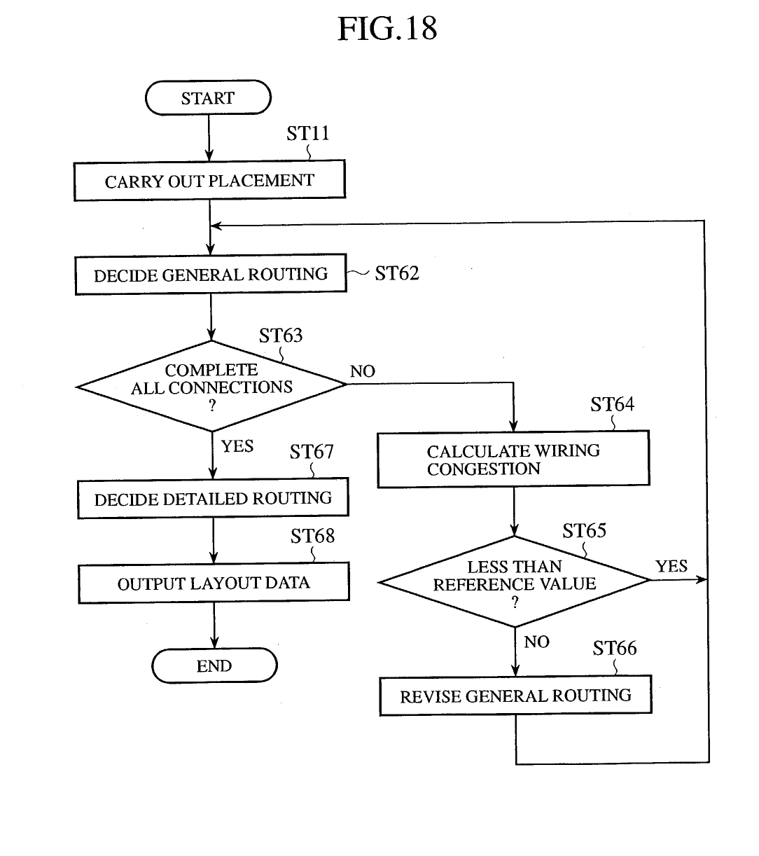

FIG. 18 is a flowchart illustrating the operation of the embodiment 6 of the automatic placement and routing system.

First, the placement unit 12 carries out placement of the memory macro cells and fuse macro cells as in the foregoing embodiment 1 (step ST11).

Subsequently, the general routing unit 193 receives the layout data 18 and connection information 19 after the macro cell placement the placement unit 12 outputs, and decides the general routing of a given connection in accordance with the connection information 19 (step ST62).

Subsequently, the general routing unit 193 makes a decision as to whether the general routing of all the connections has been decided or not (step ST63).

If the general routing of some connection has not yet been decided, the calculation unit 194 receives the general routing intermediate information 200 the general routing unit 193 outputs, and calculates the wiring congestion between the memory macro cells and fuse macro cell from the general routing intermediate information 200 (step ST64).

Subsequently, the decision unit 195 receives the wiring congestion information 202 the calculation unit 194 outputs, and makes a decision as to whether the wiring congestion is less than the reference value (step ST65). The decision is made by comparing the wiring congestion information 202 with the reference value.

Subsequently, the revision unit 196 receives the decision information 203 the decision unit 195 outputs.

When the wiring congestion is less than the reference value, the revision unit 196 does not revise the general routing of the connection whose general routing has already been decided. Subsequently, the general routing unit 193, receiving the general routing decision instruction 204 from the revision unit 196, decides the general routing of the next connection (step ST62).

In contrast, when the wiring congestion is greater than the reference value, the revision unit 196 revises the general routing of the specified connection among the connections whose general routing has already been decided (step ST66). The revision of the general routing is carried out by exchanging the terminals of the fuse macro cell to which the terminals of the memory macro cells are connected. The exchange of the terminals of the fuse macro cell is made in such a manner that the wiring congestion becomes less than the reference value. Subsequently, the general routing unit 193 receives the general routing decision instruction 204 from the revision unit 196, and decides the general routing of the next connection (step ST62).

Once the general routing of all the connections has been decided, the detailed routing unit 197 receives the general routing final information 201 the general routing unit 193 outputs and the layout data 18 after the macro cell placement the placement unit 12 outputs, and decides the final routing (detailed routing) of the individual connections in accordance with the general routing final information 201 (step ST67).

Subsequently, the detailed routing unit 197 outputs the layout data 9 after the placement and routing (step ST68).

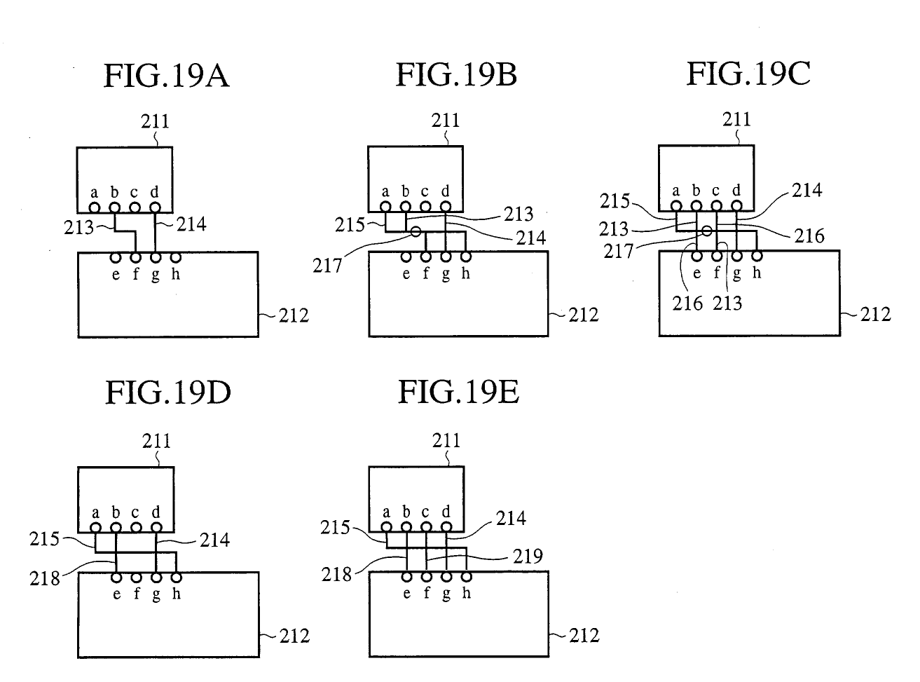

FIG. 19 is a diagram sequentially illustrating the layouts of the semiconductor circuit designed by using the embodiment 6 of the automatic placement and routing system. FIG. 19 illustrates an example which revises the general routing of the specified connection to prevent the general routing of the next connection from passing through the wiring congestion section at which the general routing of two connections overlaps, thereby designing the semiconductor circuit with a reduced wiring congestion.

From FIG. 19(a) to FIG. 19(e), a memory macro cell 211 is placed oppositely to a fuse macro cell 212. On the side of the memory macro cell 211 closest to the fuse macro cell 212, there are provided terminals a-d for making a connection with the fuse macro cell 212. On the side of the fuse macro cell 212 closest to the memory macro cell 211, there are provided terminals e-h for making a connection with the memory macro cell 211.

As illustrated in FIG. 19(a), the general routing 213 of a first connection connects the terminal b of the memory macro cell 211 to the terminal f of the fuse macro cell 212, and the general routing 214 of a second connection connects the terminal d of the memory macro cell 211 to the terminal g of the fuse macro cell 212.

As illustrated in FIG. 19(b), the general routing 215 of a third connection connects the terminal a of the memory macro cell 211 to the terminal h of the fuse macro cell 212.

Deciding the general routing of a fourth connection in the condition of FIG. 19(b) will cause the general routing 216 of a fourth connection to connect the terminal c of the memory macro cell 211 to the terminal e of the fuse macro cell 212 with passing through a wiring congestion section 217 at which the general routing 213 overlaps with the general routing 215 as illustrated in FIG. 16(c). Considering this, the revision of the general routing 213 of the first connection is made in such a manner that the terminal b of the memory macro cell 211 is connected to the terminal e of the fuse macro cell 212 in the condition of FIG. 19(b).

As illustrated in FIG. 19(d), the revised general routing 218 of the first connection connects the terminal b of the memory macro cell 211 to the terminal e of the fuse macro cell 212.

Deciding the general routing of the fourth connection in the condition of FIG. 19(d) causes the general routing 219 of the fourth connection to connect the terminal c of the memory macro cell 211 to the terminal f of the fuse macro cell 212 with preventing it from passing through the wiring congestion section as illustrated in FIG. 19(e). Consequently, the wiring congestion is less heavy in the condition of FIG. 19(e) than that of FIG. 19(c).

As described above, the present embodiment 6 calculates the wiring congestion every time the general routing of each connection is decided, and revises the general routing such that the wiring congestion becomes less than the reference value. Accordingly, setting the reference value at an appropriate value enables the reduction in the wiring congestion between the memory macro cells and fuse macro cell. This makes it possible to design a semiconductor circuit with a smaller layout size.

Furthermore, the present embodiment 6 calculates the wiring congestion every time the general routing of each connection has been decided, and revises the general routing in accordance with the calculation result. Consequently, it can reduce the processing time for the revision of the general routing as compared with the embodiment 5 which calculates the wiring congestion every time the detailed routing of each connection has been decided, and revises the detailed routing in accordance with the calculation result.

What is claimed is:

1. An automatic placement and routing system comprising:
a placement unit for making placement of memory cells and fuse cells;
a general routing unit for deciding general routing of individual connections of a net in accordance with a netlist indicating which terminals of the memory cells are to be connected to which terminals of the fuse cells, which are placed by said placement unit;
a calculation unit for calculating a predetermined information value about the net;
a revision unit for revising the general routing of a specified connection, when the predetermined information value about the net is greater than a reference value; and
a detailed routing unit for deciding, when the predetermined information value about the net is less than the reference value, detailed routing of the individual connections in accordance with the general routing the general routing unit decides, and for deciding, when the predetermined information value about the net is greater than the reference value, the detailed routing of the individual connections in accordance with the revised general routing said revision unit produces.

2. The automatic placement and routing system according to claim 1, wherein the predetermined information value about the net is a sum total of distances of the individual connections along the general routing.

3. The automatic placement and routing system according to claim 1, wherein the predetermined information value about the net is a sum total of distances of the individual connections between the terminals of the memory cells and the terminals of the fuse cells, the distances being obtained under an assumption that the terminals of the memory cells are located at centers of the memory cells.

4. The automatic placement and routing system according to claim 1, wherein said revision unit carries out the revision of the general routing by exchanging the terminals of the fuse cells, to which the memory cells are connected, on a memory cell by memory cell basis.

5. The automatic placement and routing system according to claim 1, wherein said revision unit carries out the revision of the general routing by exchanging the terminals of the fuse cells, to which the memory cells are connected, on a terminal by terminal basis.

6. The automatic placement and routing system according to claim 1, wherein
said placement unit places the memory cells and the fuse cells in such a manner that their opposing sides become parallel;
the predetermined information value about the net is a density of wiring components parallel to the opposing sides of the memory cells and the fuse cells; and
said calculation unit calculates the density of the wiring components from the general routing said general routing unit decides.

7. The automatic placement and routing system according to claim 6, wherein said revision unit carries out the revision of the general routing by exchanging the terminals of the fuse cells, to which the memory cells are connected, on a terminal by terminal basis within a same memory cell.

8. An automatic placement and routing system comprising:
a placement unit for making placement of memory cells and fuse cells;
a general routing unit for sequentially deciding general routing of individual connections in accordance with a netlist indicating which terminals of the memory cells are to be connected to which terminals of the fuse cells, which are placed by said placement unit;
a detailed routing unit for deciding detailed routing of each connection every time said general routing unit decides the general routing of the connection;
a calculation unit for calculating wiring congestion between the memory cells and the fuse cells from the detailed routing every time said detailed routing unit decides the detailed routing of each connection; and
a revision unit for revising, when the wiring congestion is greater than a reference value, the general routing of at least one of the connections whose general routing has already been decided, and for revising the detailed routing of the at least one of the connections in accordance with the revision of the general routing.

9. An automatic placement and routing system comprising:
a placement unit for making placement of memory cells and fuse cells;
a general routing unit for sequentially deciding general routing of individual connections in accordance with a netlist indicating which terminals of the memory cells are to be connected to which terminals of the fuse cells, which are placed by said placement unit;
a calculation unit for calculating wiring congestion between the memory cells and the fuse cells from the general routing of the connections whose general routing has already been decided, every time the general routing unit decides the general routing of each connection;
a revision unit for revising, when the wiring congestion is greater than a reference value, the general routing of at least one of the connections whose general routing has already been decided; and
a detailed routing unit for deciding detailed routing of the individual connections after said general routing unit decides the general routing of all the individual connections.

10. The automatic placement and routing system according to claim 8, wherein said revision unit carries out the revision of the general routing by exchanging the terminals of the fuse cells, to which the memory cells are connected.

11. The automatic placement and routing system according to claim 9, wherein said revision unit carries out the revision of the general routing by exchanging the terminals of the fuse cells, to which the memory cells are connected.
